(19) United States
(12) Patent Application Publication
(10) Pub. No.: US 2010/0161279 A1
(43) Pub. Date: Jun. 24, 2010

(54) METHOD FOR DIAGNOSIS OF ACTUATORS

(75) Inventors: Thomas KLEEGREWE, Minden (DE); Wolfgang SCHOLZ, Minden (DE)

Correspondence Address: BUCHANAN, INGERSOLL & ROONEY PC, POST OFFICE BOX 1404, ALEXANDRIA, VA, 22313-1404, US

(73) Assignee: ABB TECHNOLOGY AG, Zurich (CH)

(21) Appl. No.: 12/638,561

(22) Filed: Dec. 15, 2009

(30) Foreign Application Priority Data
Dec. 19, 2008 (DE) 10 2008 064 001.8

(51) Int. Cl. G06F 15/00

(52) U.S. Cl. 702/183

(57) ABSTRACT

A method is disclosed for diagnosis of actuators which are operated with the aid of a positioning device as a function of a nominal value preset, which is emitted from a superordinate regulation device and is received via a communication interface. Diagnosis information can be determined from a time profile of the nominal value preset by investigating the profile of the nominal value for one or more known characteristics.

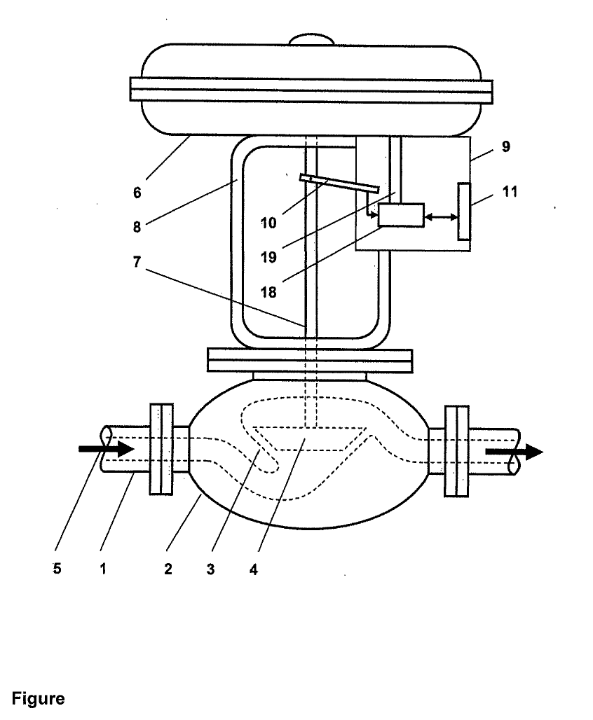

### RELATED APPLICATION

This application claims priority under 35 U.S.C. §119 to German Patent Application No. 10 2008 064 001.8 filed in Germany on Dec. 19, 2008, the entire content of which is hereby incorporated by reference in its entirety.

### FIELD

The disclosure relates to a method for diagnosis of actuators, such as actuators used in process facilities for automation technology.

### BACKGROUND INFORMATION

It is known to diagnose an actuator using a digital pneumatic position regulator, or electrical/electrohydraulic actuating drive, based on algorithms which convert data from an internal sensor system to diagnostic information.

Digital pneumatic position regulators, digital electrical or electrohydraulic actuating drives,—referred to in the following text as a positioning device—are known which have an integral capability for self-diagnosis or actuator diagnosis, in which the actuator is, for example, in the form of a valve, flap, ball cock or tap cock. Examples are the diagnosis of increased valve friction derived from increased torques of the motor or higher pressure differences in the opposite chambers of a double-acting pneumatic drive.

DE 102 09 545 A1 discloses a method for on-line detection of valve data, in which operating parameters and/or state parameters are detected, and the technical functional state of the valve is deduced. In this case, it is proposed on the one hand that small oscillations or small deflections about the operating point be excited in order to obtain state parameters during operation, and that corresponding reaction variables be measured at these moments.

Furthermore, the use of operation-specific or process-specific nominal value changes during operation to obtain the state parameters is mentioned, in order to determine the direction-dependent drive pressure (drive force), at which the valve is caused to move and, from this, to determine the state parameters thereof.

Positioning devices are known components of a control loop having at least one measurement point, at least one regulator and one actuator. The output of the regulator is passed as a nominal value to the input of the positioning device.

Known diagnosis as described above is restricted to analysis of internal data.

### SUMMARY

A method is disclosed for diagnosis of an actuator for automation technology, comprising: emitting a nominal value preset for a positioning device associated with the actuator using a communication interface; and determining diagnosis information of the actuator from a time profile of the nominal value preset by investigating the profile of the nominal value for a known characteristic.

### BRIEF DESCRIPTION OF THE DRAWINGS

Other objects and advantages of the present invention will become apparent from the following detailed description of exemplary embodiments, when used in conjunction with the drawing, wherein:

The single Figure shows an exemplary process valve installed as an actuating member in a pipeline of a process installation.

### DETAILED DESCRIPTION

Exemplary embodiments are directed to determining operating parameters and/or state parameters of an actuator.

The disclosure relates to an actuator which is controlled with the aid of a positioning device associated with the actuator as a function of a nominal value preset of the positioning device, which is emitted from a superordinate regulation device.

According to the disclosure, diagnosis information can be determined from a time profile of the nominal value preset. In this case, the profile of the nominal value which the positioning device receives from the “superordinate” regulator is investigated for one or more known characteristics, and diagnosis information is derived from this.

Exemplary embodiments can obtain diagnosis information which cannot be observed by measurement of actual values on the object of interest itself.

Exemplary embodiments will be explained in more detail in the following text.

Referring to the Figure, an interior of a the process valve 2 has a closure body 4, which interacts with a valve seat 3, in order to control the amount of process medium 5 passing through. The closure body 4 is operated linearly by a pneumatic actuating drive 6 via a push rod 7. The actuating drive 6 is connected to the process valve 2 via a yoke 8. A digital position regulator 9, such as a superordinate regulator, is fitted to the yoke 8.

The travel of the push rod 7 can be signalled to the position regulator 9 via a position sensor 10. The detected travel can be compared in control electronics 18 with a nominal value preset supplied via a communication interface 11, and the actuating drive 6 can be operated as a function of the determined regulation discrepancy. The control electronics 18 of the position regulator 9 operate an I/P converter in order to convert an electrical regulation discrepancy to an adequate control pressure. The I/P converter of the position regulator 9 can be connected to the actuating drive 6 via a pressure medium supply 19.

The position sensor 10 is connected to the rotation shaft of a potentiometer in the position regulator 9 and has an eye in which a driver on the push rod 7 engages.

A process valve 2, with a high difference between static friction and sliding friction, results in the nominal value having a sawtooth profile. The high static friction means that, despite a change having been made to the nominal value by the superordinate regulator, a steeply rising change in the nominal value occurs first of all, as a result of locking—the so-called wind-up effect—followed by immediate “braking”, by halting (e.g., discontinuing or reducing) the nominal value as soon as the process valve 2 has broken free.

If a characteristic sawtooth profile such as this is identified when the time profile of the nominal value is observed, such a characteristic is considered to correspond to a feature having occurred which is assessed as a high difference between the static friction and sliding friction of the actuator in process valve 2.

It is further possible for any feature which has occurred, such as the high difference between the static and sliding friction, to be signalled via the communication interface 11 to a superordinate device.

Furthermore, it is possible for the actuating response of the control electronics 18 of the position regulator 9 to be adapted to the feature which has occurred, and to compensate for its effect (e.g., compensate the nominal value preset for a high static friction at startup).

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 Pipeline
2 Process valve
3 Valve seat
4 Closure body
5 Process medium
6 Actuating drive
7 Valve rod
8 Yoke
9 Position regulator
10 Position sensor
11 Communication interface
18 Control electronics
19 Pressure medium supply

What is claimed is:

1. A method for diagnosis of an actuator for automation technology, comprising:
emitting a nominal value preset for a positioning device associated with the actuator using a communication interface; and
determining diagnosis information of the actuator from a time profile of the nominal value preset by investigating the profile of the nominal value for a known characteristic.

2. The method as claimed in claim 1, comprising:
signalling a feature which has occurred, and which corresponds to the known characteristic, via the communication interface to a superordinate device.

3. The method as claimed in claim 2, comprising:
adapting an actuating response of the positioning device to the feature which has occurred.

4. The method as claimed in claim 1, comprising:
receiving the nominal preset value via the communication interface from a superordinate device.

5. The method as claimed in claim 2, wherein the feature is a difference between static friction and sliding friction of the actuator.
